(19) United States
(12) Patent Application Publication
(10) Pub. No.: US 2025/0379398 A1
(43) Pub. Date: Dec. 11, 2025

(54) MAGNETICALLY ALIGNED BREAK-AWAY ELECTRICAL CONNECTOR

(71) Applicant: WINCHESTER INTERCONNECT CORPORATION, Norwalk, CT (US)

(72) Inventor: John Benham, New Milford, CT (US)

(21) Appl. No.: 19/182,742

(22) Filed: Apr. 18, 2025

Related U.S. Application Data
(60) Provisional application No. 63/658,189, filed on Jun. 10, 2024.

(51) Int. Cl. H01R 13/62; H01R 13/629

(52) U.S. Cl. CPC H01R 13/6205; H01R 13/629

(57) ABSTRACT

An electrical connector assembly is disclosed, comprising an electrical plug and an electrical receptacle. The plug includes a plurality of electrical contacts housed within a plug housing, which also contains three asymmetrically arranged magnetically attractive plug targets. The plug housing further defines a first plurality of alignment features. The receptacle includes a plurality of electrical sockets within a receptacle housing, which similarly contains three asymmetrically arranged magnetically attractive receptacle targets. The receptacle housing defines a second plurality of alignment features designed to sequentially engage with the first plurality of alignment features on the plug. This engagement is configured to progressively reduce positional tolerance between the electrical sockets and contacts, ensuring precise alignment and connection. The asymmetrical arrangement of the magnetically attractive targets enhances the reliability of the alignment of the magnetic coupling between the plug and receptacle, facilitating reliable electrical connectivity.

### CROSS-REFERENCE TO RELATED APPLICATIONS

This application claims the benefit of and priority to U.S. Provisional Application 63/658,189, titled “Magnetic Breakaway Electrical Connector”, filed Jun. 10, 2024, the contents of which are incorporated by reference herein.

### TECHNICAL FIELD

The subject matter disclosed herein relates to an electrical connector and more particularly related to a magnetic breakaway electrical connector.

### BACKGROUND

A standard National Electrical Manufacturers Association (NEMA) style blade contact requires axial disengagement from the corresponding socket to minimize the risk of damaging the power and mating connector. Lateral disengagement will damage the plug and socket connectors and may create a danger of exposing conductors and potential electrical shock. Breakaway connectors are typically provided in a cable-to-cable termination where an axial pull will disengage at a predetermined force. Any lateral disengagement will damage the mated connectors. This is a type of connector that cannot be used on a mounted or fixed connector such as a panel mount.

Traditional electrical connector assemblies have typically relied on mechanical alignment features to ensure proper mating between plugs and receptacles. These mechanical features often include pins and sockets or grooves and rails, which must be precisely aligned to establish a reliable electrical connection. However, achieving such precision can be challenging, especially in applications where connectors are frequently mated and unmated or are not conveniently placed for visual confirmation of alignment. Additionally, the reliance on purely mechanical alignment can result in increased manufacturing complexity and cost.

It would be beneficial to develop a connector design that provides improved alignment and connection reliability.

### SUMMARY

In some aspects, the techniques described herein relate to an electrical connector assembly, including an electrical plug including a plurality of electrical contacts, a plug housing in which the plurality of electrical contacts are disposed, magnetically attractive plug targets embedded within the plug housing and asymmetrically arranged around the plurality of electrical contacts, and a first plurality of alignment features defined by the plug housing, and an electrical receptacle including a plurality of electrical sockets, a receptacle housing in which the plurality of electrical sockets are disposed, magnetically attractive receptacle targets embedded within the receptacle housing and asymmetrically arranged around the plurality of electrical sockets and a second plurality of alignment features defined by the receptacle housing being configured to sequentially engage the first plurality of alignment features of an electrical plug, engagement of the first plurality of alignment features and the second plurality of alignment features being configured to sequentially reduce a positional tolerance between the plurality of electrical sockets and the plurality of electrical contacts.

In some aspects, the techniques described herein relate to an electrical plug, including a plurality of electrical contacts, a plug housing in which the plurality of electrical contacts are disposed, magnetically attractive targets embedded within the plug housing and asymmetrically arranged around the plurality of electrical contacts, and a plurality of alignment features defined by the plug housing and configured to sequentially engage a corresponding plurality of alignment features of an electrical receptacle, engagement of the plurality of alignment features of the electrical plug and the corresponding plurality of alignment features of the electrical receptacle being configured to sequentially reduce a positional tolerance between the plurality of electrical contacts and a corresponding plurality of electrical sockets of the electrical receptacle.

In some aspects, the techniques described herein relate to an electrical receptacle, including a plurality of electrical sockets, a receptacle housing in which the plurality of electrical sockets are disposed, magnetically attractive targets embedded within the receptacle housing and asymmetrically arranged around the plurality of electrical sockets, and a plurality of alignment features defined by the receptacle housing and configured to sequentially engage a corresponding plurality of alignment features of an electrical plug, engagement of the plurality of alignment features of the electrical receptacle and the corresponding plurality of alignment features of the electrical plug being configured to sequentially reduce a positional tolerance between the plurality of electrical sockets and a corresponding plurality of electrical contacts of the electrical plug.

### BRIEF DESCRIPTION OF THE DRAWINGS

FIG. 1 is an isometric view of an electrical connector with magnetic breakaway features according to some embodiments.

FIG. 2 is an isometric front view of a plug of the electrical connector of FIG. 1 according to some embodiments.

FIG. 3 is an isometric front view of a receptacle of the electrical connector of FIG. 1 according to some embodiments.

FIG. 4 is cross-section isometric view of the electrical connector of FIG. 1 with a plug housing cover removed according to some embodiments.

FIG. 5 is a front view of the electrical connector of FIG. 1 according to some embodiments.

FIG. 6 is a side cross-section view of the plug of FIG. 2 in a pre-mated condition according to some embodiments.

FIG. 7A has a front view of the electrical connector of FIG. 1 according to some embodiments.

FIG. 7B is a side cross-section view of the connector insulator of FIG. 7A according to some embodiments.

FIG. 8A is an isometric view of a power contact of the electrical connector of FIG. 1 according to some embodiments.

FIG. 8B is a side cross-section view of a power contact of FIG. 8A according to some embodiments.

FIG. 8C is an isometric view of a signal contact of the electrical connector of FIG. 1 according to some embodiments.

FIG. 8D is a side cross-section view of a signal contact of FIG. 8C according to some embodiments.

### DETAILED DESCRIPTION

An electrical power connector assembly that can pivot and disconnect at a predetermined force with either an axial or lateral disengagement path is presented herein. The electrical power connector assembly shown here may be well suited for providing electrical power to medical hardware, such as a hospital bed that may benefit from the withstanding inadvertent disconnection without damage to the plug or receptacle of the connector assembly.

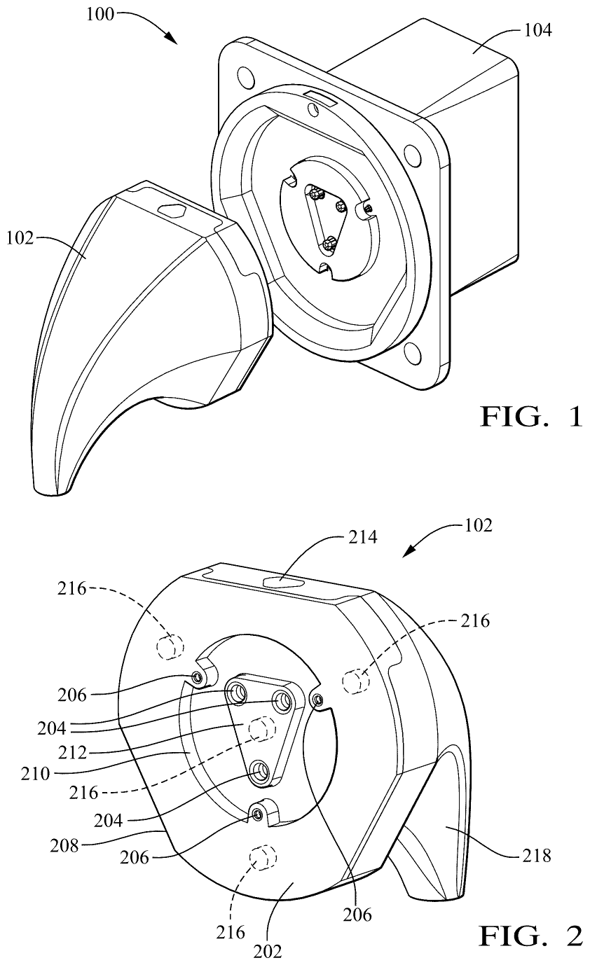

An electrical power connector assembly 100 is shown in FIG. 1 and includes an electrical plug, hereafter referred to as the plug 102 and an electrical receptacle, hereafter referred to as the receptacle 104.

As shown in FIG. 2, the plug 102 includes an insulative plug housing 202 containing a plurality of electrical contacts, hereafter referred to as the plug power contacts 204 and the plug signal contacts 206. The housing 202 includes an embossed primary alignment feature 208 that is configured to cooperate with a corresponding recessed primary alignment feature 302 (shown in FIG. 3) in the receptacle 104 to provide a rotational alignment between the plug power and signal contacts 204, 206 and electrical contacts, hereafter referred to as the receptacle power contacts 304 and the receptacle signal contacts 306 in an insulative receptacle housing 310 of the receptacle 104. As used herein, the term “alignment” refers to a rotational or radial alignment between the plug 102 and the receptacle 104 around their central longitudinal axes.

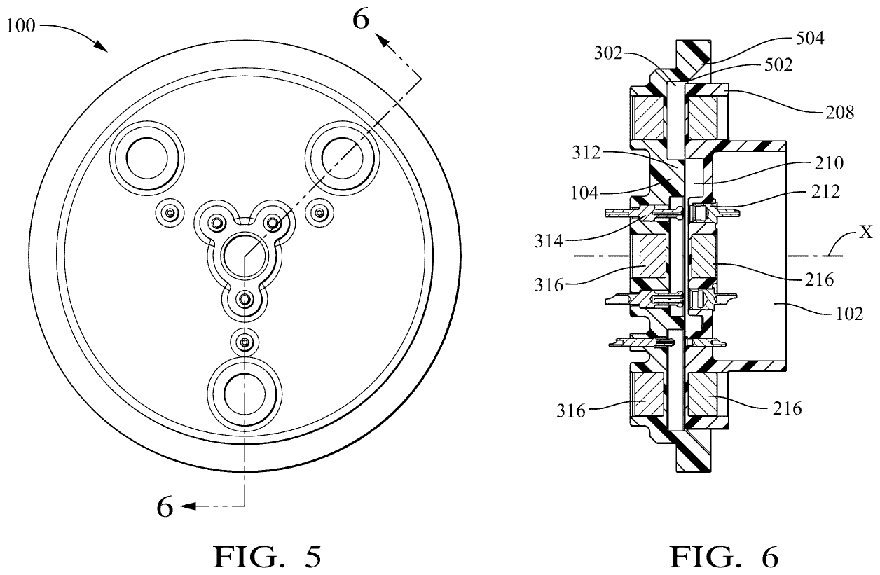

The edges of the primary alignment features 208, 302 have complementary tapered sides defining a first taper angle in the range of 45° to 60°. The primary alignment is established by the engagement of the retaining magnets 316 with the magnetic targets 216. Orientation of the retaining magnets 316 and the magnetic targets 216 (see FIG. 5) helps with the gross alignment, rotating the plug 102 toward a 12 o'clock alignment with the receptacle 104. A secondary clocking alignment is initiated by the conical 45° to 60° lead in chamfer on the receptacle 104. The third insulator alignment feature (see FIG. 6) reduces radial misalignment by 0.018″. The fourth alignment feature reduces radial mis-alignment to 0.013″, the fifth alignment reduces radial misalignment within 0.004″. The sixth alignment feature is the contact lead in geometry.

The receptacle 104 and plug 102 may also include position indicators 214, 318, that may be used for initial visual alignment of the receptacle 104 and plug 102 prior to engaging the plug 102 with the receptacle 104.

The receptacle housing 310 further includes an array of embedded retaining magnets 316 that attract a corresponding array of embedded magnetic targets 216 in the plug 102. The retaining magnets 316 and magnetic targets 216 cooperate to attach and retain the plug 102 to the receptacle 104.

The plug housing 202 further includes a plug housing cover 218 configured to provide strain relief to an electrical cable (not shown) connected to the plug 102.

As shown in FIG. 3, the receptacle housing 310 also includes a flange 320 is configured to secure the receptacle housing 310 to a substrate, such as a hospital bed frame. The receptacle housing 310 may also include an O-ring seal confirmed to provide an IP-69 compliant ingress protection seal according to the IEC 60529 standard defined by the International Electrotechnical Commission (IEC) to protect the assembly during wash down and cleaning operations. The distal enclosure of the receptacle housing 310 may additionally include a NEMA standard outlet such as a NEMA 5-15 (not shown) to supply electrical power from the receptacle 104 to peripheral equipment such as monitors and/or computers.

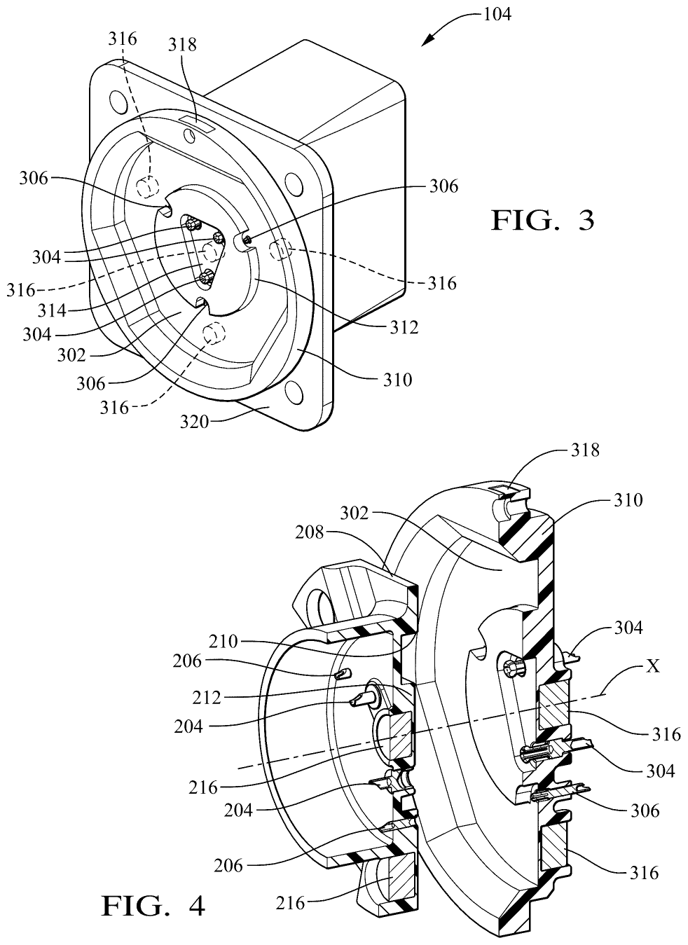

FIG. 4 is a cross-section view of the receptacle 104 showing the array of retaining magnets 316. The retaining magnets 316 are preferably permanent magnets, such as ferrite or neodymium magnets.

The magnetic targets 216 in the plug housing 202 may be made of a non-magnetized but magnetically attractive material, e.g., a ferrous material, embedded in the plug housing 202. It may be preferable for the magnetic targets 216 in the plug housing 202 be be non-magnetized so that stray metallic particles are not drawn to the plug 102 when it is disconnected from the receptacle 104. The retaining magnets 316 and the magnetic targets 216 may be configured to maintain a retention force of up to 66.7 newtons (15 lbs_{f}) and a lateral force of 35.6 newtons (8 lbs_{f}) for retaining the attachment of the plug 102 to the receptacle 104 (see FIG. 4). In a non-limiting example, the plug power contacts 204 may have a diameter of 3.6 mm (0.14 in) and engage with the mating receptacle power contacts 306 by a mating distance of 1.5 mm (0.06 in).

In other embodiments, the magnetic targets in the receptacle and the plug housings may be magnets with opposing polarity to increase the retention force or reduce the mass of the retaining magnets and magnetic targets. In yet other embodiments, the magnetic targets may be embedded in the plug housing and a non-magnetized magnetic target may be embedded in the receptacle housing.

In the illustrated example, the magnetic targets 216 in the plug housing 202 are arranged around the receptacle power and signal contacts 204, 206 in an isosceles triangular configuration. For example, as shown in FIG. 5, two of the magnetic targets 216 are in locations offset from the 12 o'clock position by 45° and a third magnetic target 216 is located at the 6 o'clock position. A fourth magnetic target 216 may be axially arranged along the longitudinal axis X. In other embodiments different arrangements of the magnetic targets in a two-axis asymmetrical pattern may be used.

As shown in FIG. 6, there are at least 5 sequential stages in the alignment of the plug 102 and the receptacle 104.
Stage 1—engagement of the retaining magnets 316 and the magnetic targets 216
Stage 2—engagement of an outer edge 502 of the primary alignment feature 208 of the plug 102 with a tapered lead-in 504 of the primary alignment feature 302 in the receptacle 104.
Stage 3—entry of the embossed primary alignment feature 208 of the plug 102 into the recessed primary alignment feature 302 in the receptacle 104.
Stage 4—entry of the embossed secondary alignment feature 312 of the receptacle 104 into the recessed secondary alignment feature 210 in the plug 102.
Stage 5—entry of the embossed tertiary alignment feature 212 of the plug 102 into the recessed tertiary alignment feature 314 in the receptacle 104.

Stages 3, 4, and 5 sequentially reduce radial misalignment of the alignment between the plug power and signal contacts 204, 206 and the receptacle power and signal contacts 304, 306 and as the plug 102 is mated with the receptacle 104. The height, i.e., the protrusion distance of the embossed primary alignment feature 208 of the face of the plug is greater than the height of the embossed secondary alignment feature 312 from the face of the receptacle 104, which is also greater than the height of the embossed tertiary alignment feature 212 from the face of the plug. This height difference provides the sequential engagement of the alignment features in Stages 3, 4, and 5.

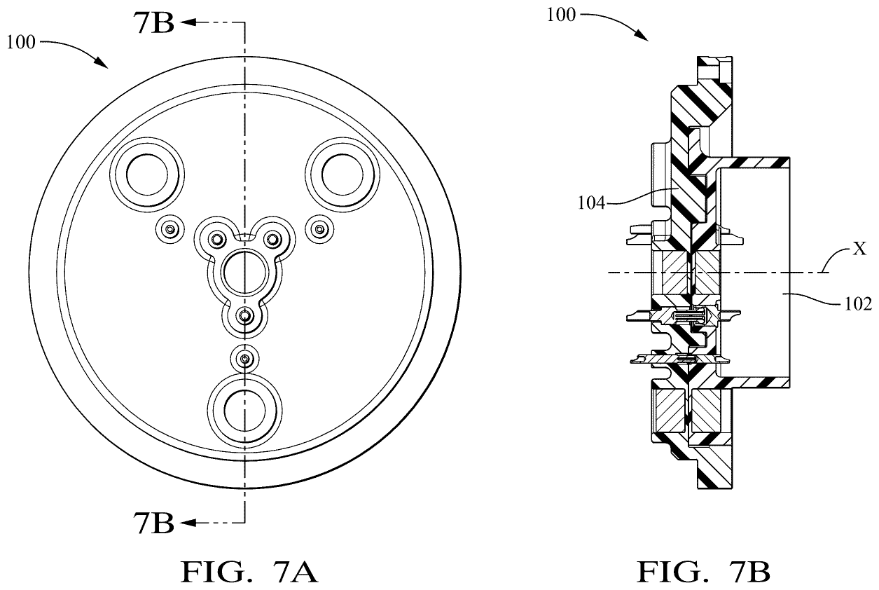

The retaining magnets 316 in the receptacle housing 310 are arranged around the receptacle power and signal contacts 304, 306 in an isosceles triangular configuration. For example, as shown in FIG. 7A, two of the retaining magnets 316 are in offset locations from the 12 o'clock position by 45° and a third retaining magnet 316 is located at the 6 o'clock position. A fourth retaining magnet 316 may be axially arranged along the longitudinal axis X. In other embodiments different arrangements of the retaining magnets in a two-axis asymmetrical pattern may be used. The orientation of the magnetic targets 216 and the retaining magnets 316 shown in FIGS. 5 and 7A provides a gross alignment feature that is configured to rotate the plug housing 202 toward a 12 o'clock alignment relative to the receptacle housing 310 due to the unbalanced magnetic forces acting on the plug housing 202.

The plug power and signal contacts 204, 206 and the receptacle power and signal contacts 304, 306 are radially placed on the plug and receptacle housings 202, 310 with a relationship to facilitate a disengagement path for the mated the plug power and signal contacts 204, 206 and the receptacle power and signal contacts 304, 306 and the plug and receptacle housings 202, 310. Free disengagement can occur with less than 0.25 mm (0.01 in) of positional mismatch (see FIGS. 7A and 7B) of the unmating path.

In a lateral breakaway or uncontrolled disconnection of the plug 102 from the receptacle 104, the contact unmating path is controlled by the radial distance to the outer profile of the connector insulator as illustrated in FIGS. 7A and 7B.

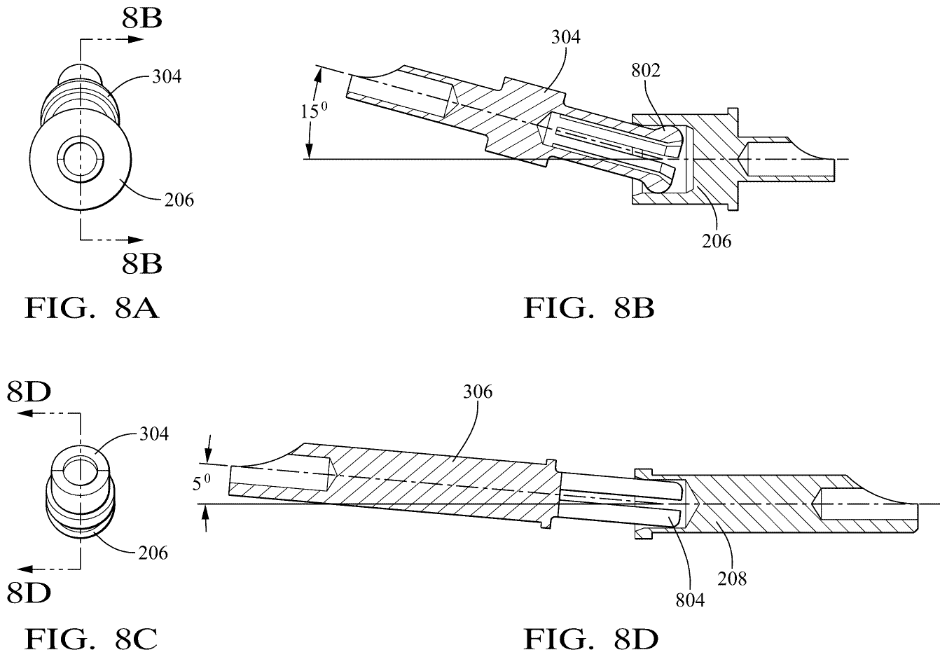

As shown in FIGS. 8A to 8D, the plug power and signal contacts 204, 206 are male plug contacts and the receptacle power and signal contacts 304, 306 are female socket contacts. The plug power contacts 204 have a ball contact point geometry 802 and provide a lead-in to the mating of the receptacle power contacts 306 and allow an angular misalignment tolerance of up to 15°. The plug signal contacts 204 have a similar ball contact point geometry 804 and provide a lead-in to the mating of the receptacle signal contacts 304 and allow an angular misalignment tolerance of up to 5°. The plug power and signal contacts 204, 206 are contoured to provide a low electrical resistance connection with the mating receptacle power and signal contacts 304, 306.

The signal contacts 206, 306 may be used to control delivery of electrical power to the power contacts 204, 304, specifically configured to deliver electrical power only when proper connection of the signal contacts 206, 306 is established. The signal contacts 206, 306 may be used also be used for transmission of other analog or digital control signals or data. Other embodiment of the electrical power converter may be envisioned that do not include separate signal contacts.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

### Discussion of Possible Embodiments

The following are non-exclusive descriptions of possible embodiments of the present invention.

In some aspects, the techniques described herein relate to an electrical connector assembly, including an electrical plug including a plurality of electrical contacts, a plug housing in which the plurality of electrical contacts are disposed, magnetically attractive plug targets embedded within the plug housing and asymmetrically arranged around the plurality of electrical contacts, and a first plurality of alignment features defined by the plug housing, and an electrical receptacle including a plurality of electrical sockets, a receptacle housing in which the plurality of electrical sockets are disposed, magnetically attractive receptacle targets embedded within the receptacle housing and asymmetrically arranged around the plurality of electrical sockets and a second plurality of alignment features defined by the receptacle housing being configured to sequentially engage the first plurality of alignment features of an electrical plug, engagement of the first plurality of alignment features and the second plurality of alignment features being configured to sequentially reduce a positional tolerance between the plurality of electrical sockets and the plurality of electrical contacts.

The assembly of the preceding paragraph can optionally include, additionally and/or alternatively any, one or more of the following features/steps, configurations and/or additional components.

In some embodiments of the assembly, the magnetically attractive plug targets are formed of a non-magnetized metallic material.

In some embodiments of the assembly, the magnetically attractive receptacle targets are arranged in an isosceles triangular pattern around the plurality of electrical sockets such that a first and second of the magnetically attractive receptacle targets are placed in an upper quadrant centered on a 12 o'clock position and wherein a third of the magnetically attractive receptacle targets is placed in a lower quadrant centered on a 6 o'clock position.

In some embodiments of the assembly, a first distance between a first target and a second target of the magnetically attractive targets is nonequal to a second distance between the second target and a third target of the magnetically attractive targets.

In some embodiments of the assembly, the first plurality of alignment features are each spaced at different distances from a face of the plug housing and the second plurality of alignment features are each spaced at different distances from a face of the receptacle housing.

In some embodiments of the assembly, each of the plurality of electrical contacts has a rounded tip is configured to provide electrical connectivity with each corresponding electrical socket when an axis of the electrical contact is non-coaxial with an axis of the electrical socket.

In some aspects, the techniques described herein relate to an electrical plug, including a plurality of electrical contacts, a plug housing in which the plurality of electrical contacts are disposed, magnetically attractive targets embedded within the plug housing and asymmetrically arranged around the plurality of electrical contacts, and a plurality of alignment features defined by the plug housing and configured to sequentially engage a corresponding plurality of alignment features of an electrical receptacle, engagement of the plurality of alignment features of the electrical plug and the corresponding plurality of alignment features of the electrical receptacle being configured to sequentially reduce a positional tolerance between the plurality of electrical contacts and a corresponding plurality of electrical sockets of the electrical receptacle.

The plug of the preceding paragraph can optionally include, additionally and/or alternatively any, one or more of the following features/steps, configurations and/or additional components.

In some embodiments of the plug, the magnetically attractive targets are formed of a non-magnetized metallic material.

In some embodiments of the plug, the magnetically attractive plug targets are arranged in an isosceles triangular pattern around the plurality of electrical sockets such that a first and second of the magnetically attractive plug targets are placed in an upper quadrant centered on a 12 o'clock position and wherein a third of the magnetically attractive plug targets is placed in a lower quadrant centered on a 6 o'clock position . . . .

In some embodiments of the plug, a first distance between a first target and a second target of the magnetically attractive targets is nonequal to a second distance between the second target and a third target of the magnetically attractive targets.

In some embodiments of the plug, the plurality of alignment features are each spaced at different distances from a face of the plug housing.

In some embodiments of the plug, each of the plurality of electrical contacts has a rounded tip is configured to provide electrical connectivity with each corresponding electrical socket in the electrical receptacle when an axis of the electrical contact is non-coaxial with an axis of the electrical socket.

In some embodiments of the plug, a first portion of the plurality of electrical contacts are electrical power contacts and a second portion of the plurality of electrical contacts are electrical signal contacts.

In some aspects, the techniques described herein relate to an electrical receptacle, including a plurality of electrical sockets, a receptacle housing in which the plurality of electrical sockets are disposed, magnetically attractive targets embedded within the receptacle housing and asymmetrically arranged around the plurality of electrical sockets, and a plurality of alignment features defined by the receptacle housing and configured to sequentially engage a corresponding plurality of alignment features of an electrical plug, engagement of the plurality of alignment features of the electrical receptacle and the corresponding plurality of alignment features of the electrical plug being configured to sequentially reduce a positional tolerance between the plurality of electrical sockets and a corresponding plurality of electrical contacts of the electrical plug.

The receptacle of the preceding paragraph can optionally include, additionally and/or alternatively any, one or more of the following features/steps, configurations and/or additional components.

In some embodiments of the receptacle, the magnetically attractive targets are formed of a magnetized material.

In some embodiments of the receptacle, the magnetically attractive receptacle targets are arranged in an isosceles triangular pattern around the plurality of electrical sockets such that a first and second of the magnetically attractive receptacle targets are placed in an upper quadrant centered on a 12 o'clock position and wherein a third of the magnetically attractive receptacle targets is placed in a lower quadrant centered on a 6 o'clock position . . . .

In some embodiments of the receptacle, the plurality of alignment features are each spaced at different distances from a face of the receptacle housing.

In some embodiments of the receptacle, each of the plurality of electrical sockets is configured to provide electrical connectivity with a corresponding contact in the electrical plug having a rounded tip when an axis of the electrical socket is non-coaxial with an axis of the electrical contact.

In some embodiments of the receptacle, a first distance between a first target and a second target of the magnetically attractive targets is nonequal to a second distance between the second target and a third target of the magnetically attractive targets.

In some embodiments of the receptacle, a first portion of the plurality of electrical contacts are electrical power contacts and a second portion of the plurality of electrical contacts are electrical signal contacts.

1. An electrical connector assembly, comprising:
an electrical plug including a plurality of electrical contacts, a plug housing in which the plurality of electrical contacts are disposed, magnetically attractive plug targets embedded within the plug housing and asymmetrically arranged around the plurality of electrical contacts, and a first plurality of alignment features defined by the plug housing; and
an electrical receptacle including a plurality of electrical sockets, a receptacle housing in which the plurality of electrical sockets are disposed, magnetically attractive receptacle targets embedded within the receptacle housing and asymmetrically arranged around the plurality of electrical sockets and a second plurality of alignment features defined by the receptacle housing being configured to sequentially engage the first plurality of alignment features of an electrical plug, engagement of the first plurality of alignment features and the second plurality of alignment features being configured to sequentially reduce a positional tolerance between the plurality of electrical sockets and the plurality of electrical contacts.

2. The electrical connector assembly in accordance with claim 1, wherein the magnetically attractive plug targets are formed of a non-magnetized metallic material.

3. The electrical connector assembly in accordance with claim 1, wherein the magnetically attractive receptacle targets are arranged in an isosceles triangular pattern around the plurality of electrical sockets such that a first and second of the magnetically attractive receptacle targets are placed in an upper quadrant centered on a 12 o'clock position and wherein a third of the magnetically attractive receptacle targets is placed in a lower quadrant centered on a 6 o'clock position.

4. The electrical connector assembly in accordance with claim 3, wherein a first distance between a first target and a second target of the magnetically attractive receptacle targets is nonequal to a second distance between the second target and a third target of the magnetically attractive receptacle targets.

5. The electrical connector assembly in accordance with claim 1, wherein the first plurality of alignment features are each spaced at different distances from a face of the plug housing and the second plurality of alignment features are each spaced at different distances from a face of the receptacle housing.

6. The electrical connector assembly in accordance with claim 1, wherein each of the plurality of electrical contacts has a rounded tip and is configured to provide electrical connectivity with each corresponding electrical socket when an axis of the electrical contact is non-coaxial with an axis of the electrical socket (304, 306).

7. An electrical plug, comprising:
a plurality of electrical contacts (204, 206);
a plug housing in which the plurality of electrical contacts are disposed;
magnetically attractive targets embedded within the plug housing and asymmetrically arranged around the plurality of electrical contacts; and
a plurality of alignment features defined by the plug housing and configured to sequentially engage a corresponding plurality of alignment features of an electrical receptacle, engagement of the plurality of alignment features of the electrical plug and the corresponding plurality of alignment features of the electrical receptacle being configured to sequentially reduce a positional tolerance between the plurality of electrical contacts and a corresponding plurality of electrical sockets (304, 306) of the electrical receptacle.

8. The electrical plug in accordance with claim 7, wherein the magnetically attractive targets are formed of a non-magnetized metallic material.

9. The electrical plug in accordance with claim 7, wherein magnetically attractive targets are arranged in an isosceles triangular pattern around the plurality of electrical sockets such that a first and second of the magnetically attractive targets are placed in an upper quadrant centered on a 12 o'clock position and wherein a third of the magnetically attractive targets is placed in a lower quadrant centered on a 6 o'clock position.

10. The electrical plug in accordance with claim 7, wherein a first distance between a first target and a second target of the magnetically attractive targets is nonequal to a second distance between the second target and a third target of the magnetically attractive targets.

11. The electrical plug in accordance with claim 7, wherein the plurality of alignment features are each spaced at different distances from a face of the plug housing.

12. The electrical plug in accordance with claim 7, wherein each of the plurality of electrical contacts has a rounded tip is configured to provide electrical connectivity with each corresponding electrical socket in the electrical receptacle when an axis of the electrical contact is non-coaxial with an axis of the electrical socket (304, 306).

13. The electrical plug in accordance with claim 7, wherein a first portion of the plurality of electrical contacts are electrical power contacts and a second portion of the plurality of electrical contacts are electrical signal contacts.

14. An electrical receptacle, comprising:
a plurality of electrical sockets (304, 306);
a receptacle housing in which the plurality of electrical sockets are disposed;
magnetically attractive targets embedded within the receptacle housing and asymmetrically arranged around the plurality of electrical sockets (304, 306); and
a plurality of alignment features defined by the receptacle housing and configured to sequentially engage a corresponding plurality of alignment features of an electrical plug, engagement of the plurality of alignment features of the electrical receptacle and the corresponding plurality of alignment features of the electrical plug being configured to sequentially reduce a positional tolerance between the plurality of electrical sockets and a corresponding plurality of electrical contacts of the electrical plug.

15. The electrical receptacle in accordance with claim 14, wherein the magnetically attractive targets are formed of a magnetized material.

16. The electrical receptacle in accordance with claim 14, wherein the magnetically attractive targets are arranged in an isosceles triangular pattern around the plurality of electrical sockets such that a first and second of the magnetically attractive targets are placed in an upper quadrant centered on a 12 o'clock position and wherein a third of the magnetically attractive targets is placed in a lower quadrant centered on a 6 o'clock position.

17. The electrical receptacle in accordance with claim 14, wherein the plurality of alignment features are each spaced at different distances from a face of the receptacle housing.

18. The electrical receptacle in accordance with claim 14, wherein each of the plurality of electrical sockets is configured to provide electrical connectivity with a corresponding contact in the electrical plug having a rounded tip when an axis of the electrical socket is non-coaxial with an axis of the electrical contact (204, 206).

19. The electrical receptacle in accordance with claim 14, wherein a first distance between a first target and a second target of the magnetically attractive targets is nonequal to a second distance between the second target and a third target of the magnetically attractive targets.

20. The electrical receptacle in accordance with claim 14, wherein a first portion of the plurality of electrical contacts are electrical power contacts and a second portion of the plurality of electrical contacts are electrical signal contacts.
